(19) United States
(12) Patent Application Publication
(10) Pub. No.: US 2017/0084215 A1
(43) Pub. Date: Mar. 23, 2017

(54) PLASMONIC PIXELS

(71) Applicants: Jana Olson, Houston, TX (US); Lifei Liu, Houston, TX (US); Alejandro Manjavacas, Houston, TX (US); Wei-Shun Chang, Houston, TX (US); Benjamin Foerster, Feldatal (DE); Nicholas S. King, Pearland, TX (US); Mark William Knight, Beaverton, OR (US); Peter Nordlander, Houston, TX (US); Nancy J. Halas, Houston, TX (US); Stephan Link, Houston, TX (US); Tiyash Basu, Houston, TX (US)

(72) Inventors: Jana Olson, Houston, TX (US); Lifei Liu, Houston, TX (US); Alejandro Manjavacas, Houston, TX (US); Wei-Shun Chang, Houston, TX (US); Benjamin Foerster, Feldatal (DE); Nicholas S. King, Pearland, TX (US); Mark William Knight, Beaverton, OR (US); Peter Nordlander, Houston, TX (US); Nancy J. Halas, Houston, TX (US); Stephan Link, Houston, TX (US); Tiyash Basu, Houston, TX (US)

(73) Assignee: William Marsh Rice University, Houston, TX (US)

(21) Appl. No.: 14/706,441

(22) Filed: May 7, 2015

Related U.S. Application Data
(60) Provisional application No. 61/989,641, filed on May 7, 2014.

(51) Int. Cl. G09G 3/20; G09G 3/28

(52) U.S. Cl. CPC G09G 3/2003; G09G 3/28; Y10S 977/952

(57) ABSTRACT

Plasmonic pixels may provide an array of nanoparticles in a desired arrangement on a substrate, and may be overcoated with a top layer. The nanoparticles may be nanorods, nanoshells, nanoparticles, spiky shells, cubes, triangles, prisms, disks, nanowires, gratings, Fano structures, and/or other single or coupled nano structures. The array of nanoparticles may support two polarized surface plasmon resonances. Further, a plasmon response of the array of nanoparticles may be diffractively coupled. The nanoparticles may be arranged in a square or hexagonal array. The color of the plasmonic pixel may be controlled by the plasmon response of the nanoparticles, a distance between nanoparticles along axial directions, and/or a method of excitation.

### RELATED APPLICATIONS

This application claims the benefit of U.S. Provisional Patent Application No. 61/989,641, filed on May 7, 2014, which is incorporated herein by reference.

### STATEMENT REGARDING FEDERALLY SPONSORED RESEARCH

This invention was made with government support under Grant No. 0940902, awarded by the National Science Foundation; and Grant No. N00014-10-1-0989, awarded by the U.S. Department of Defense. The government has certain rights in the invention.

### FIELD OF THE INVENTION

This invention relates to plasmonic pixels. More particularly, to plasmonic pixels comprising at least one nanoparticle.

### BACKGROUND OF INVENTION

Display technologies have gravitated toward flat displays, high resolution and/or small pixel sizes, higher energy efficiency, and improved benefit/cost ratios for the consumer. Among display technology are plasma displays and laser phosphor displays, the brightness of which generally decrease over time because the phosphors can lose luminosity over time or become chemically changed by contamination. Many phosphor displays (among other types) also suffer from image burn-in and image retention when static images are displayed on the screen for long periods of time. Light emitting diodes (LEDs) have been made of inorganics, organics, and polymers. Although LEDs are more robust against image retention issues and last longer than phosphors, they have thicker displays when backlighting sources are used. The different methods for color production in display technologies are chosen specifically because they can produce sharp spectral features at designated wavelengths in the red, green, and blue regions in the spectrum, making them compatible with standard additive color schemes, such as sRGB.

Inorganic nanoparticles have begun to infiltrate the market in the form of quantum dot LEDs (QD-LEDs), which have excellent display lifetimes and industry-scalable size-based and material-based color tunability. However, obtaining blue colors from quantum dots has been tricky because of the small size necessary to achieve it, and there has been difficulty in selecting suitable metals for nanoparticle-based colorants as well because of high cost, poor color range, or incompatibility with current complementary metal oxide semiconductor (CMOS) technology.

Aluminum has been tapped as a great color-filter material by creating a precise array of holes in an aluminum substrate, or as a polarization filter/indicator by arranging aluminum crosses in an array. Aluminum is low in cost, high in abundance, and CMOS compatible. The plasmon resonances of aluminum nanostructures have been shown to span the visible region, and they are even more sensitive to changes in physical size and shape than gold or silver. Also, as has been shown numerous times with gold, silver, and other plasmonic materials, polarized plasmon resonances in aluminum can be created using high aspect ratio nanostructures, such as nanorods, making aluminum a highly desirable metal for incorporation in display technologies. However, shifting the plasmon resonance out of the UV and into the visible region increases the plasmon linewidth due to size effects as well as aluminum's interband transition around 1.5 eV, making it a challenge to create the sharp bands necessary for use with RGB color displays.

As discussed further herein, plasmonic pixels that provide an array of nanoparticles can be utilized for color display applications.

### SUMMARY OF INVENTION

In one embodiment, plasmonic pixels may provide an array of nanoparticles. The nanoparticles may be deposited in a desired arrangement on a substrate, and may be overcoated with a top layer, such as polyimide, SiO₂, or any suitable layer with a refractive index of approximately 1.5 to 1.7. The nanoparticles may comprise any suitable nanoparticles, such as nanorods, nanoshells, nanoparticles, spiky shells, cubes, triangles, prisms, disks, nanowires, gratings, Fano structures, and/or other single or coupled nano structures. The array of nanoparticles may support two or more polarized surface plasmon resonances. Further, a plasmon response of the array of nanoparticles may be diffractively coupled. The nanoparticles are formed from Al, Au, Ag, silicon, copper, platinum, any plasmonic metal alloys, any plasmonic semiconductors and doped semiconductors, or a combination thereof. In some embodiments, the nanoparticles may be nanorods that have approximately equal dimensions, such as equal lengths (l), widths (w), and/or heights (h). A horizontal period, vertical period, and/or period between layers of nanoparticles in the array may be 2-3 times an average nanoparticle size. The nanoparticles may be arranged in a square, rectangular, or hexagonal array. A ratio of D_{y}/Dₓ may be equal to or between 1-2, where D_{y} is a period between nanoparticles along a y direction and Dₓ is a period between nanoparticles along an x direction. In some embodiments, each nanoparticle may have an approximately identical aspect ratio to provide a pixel of a single color. In other embodiments, the nanoparticles may have different aspect ratios to provide a pixel of a color that is not achievable by a single aspect ratio alone.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1C respectively show schematics of an isometric view of a pixel, SEM image of a 5 micron square plasmonic pixel, and cross section of a pixel;

FIGS. 2A-2C respectively show a composite SLR image of pixels positioned according to period ratio (Dy/Dx) and nanorod length (l); an image of highlighted pixels selected as the best red, green, and blue color in the pixel array; and image of the same region as in FIG. 2B showing the “off” state of the pixels;

FIG. 3 shows experimental and calculated spectra for selected red, green, and blue pixels;

FIGS. 4A-4C respectively show theoretical calculations of pixel spectra with three parameters, or Dₓ, D_{y}, and l, varied individually;

FIGS. 5A-5F respectively show intensity v. wavelength for seven pixels for nanorods of different lengths;

FIG. 5G shows a series of spectra for the seven pixels in FIGS. 5A-5F;

FIG. 5H provides a table of length, Dₓ, and D_{y} for pixels in FIGS. 5A-5F of various nanorod lengths in FIGS. 5A-5F;

FIGS. 6A-6C show alternative randomized nanorod sample arrangements;

FIGS. 7A-7N show additional excitation geometries used to image plasmonic pixels;

FIGS. 8A-8H show pixels in on- and off-states and associated histograms;

FIG. 9 shows a comparison between spectra of plasmonic pixels and a commercial LCD display;

FIGS. 10A-10B show spectra of each pixel, which is convolved with the human eye sensitivity spectra to obtain data points;

FIGS. 11A-11C respectively show how color can be controlled by a D_{y}-based threshold, Dx-based threshold, and selection of a single-rod resonance;

FIG. 12 shows the calculated scattering spectrum for pixels comprised of increasing numbers of nanorods;

FIG. 13 shows a macroscopic demonstration of an edge-lit pixel with and without a diffuser; and

FIG. 14 shows a schematic diagram of observable light rays from the pixel.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

Plasmonic pixel systems and methods are discussed herein. In some embodiments, plasmonic pixels may comprise an array of nanoparticles, such as nanorods. In some embodiments, the nanoparticles (i.e., nanorods) are prepared from aluminum, gold, silver or combination thereof. In some embodiments, the nanoparticles in the plasmonic pixels may include an array of aluminum nanorods. In some embodiments, plasmonic pixels may be made from nanoparticles of aluminum, gold, silver, silicon, copper, platinum, any plasmonic metal alloys, any plasmonic semiconductors and doped semiconductors, or a combination thereof, such as by forming aluminum nanorods. In some embodiments, plasmonic pixels may provide active control of different colors, such as colors of an RGB color model.

In some embodiments, plasmonic pixels may be of any suitable size and tunability in color, intensity, and/or polarization angle. In some embodiments, the plasmonic pixels comprise an array of nanorods. In some embodiments, the nanorods have dimensions of tens to hundreds of nanometers. In some embodiments, the nanorods have dimensions equal to or between 10-100 nm. In some embodiments, the nanorods have dimensions equal to or between 10-200 nm. In some embodiments, the nanorods have dimensions equal to or between 10-300 nm. In some embodiments, other plasmonic materials, such as but not limited to gold and silver, could also be used by themselves or in combination with aluminum. In some embodiments, the array of nanorods may be arranged in any suitable arrangement, such as a hexagonal or square arrangement. In some embodiments, the nanorods may have a ratio of Dy/Dx that is equal to or between 1 to 2.

In some embodiments, the nanorods support two polarized surface plasmon resonances. These resonances cause light with two well defined, tunable wavelength maximum to be scattered from the nanorod when white light is incident on it. The transverse resonance may exist in the ultraviolet (UV) spectrum of light, while the brighter and highly tunable longitudinal mode can be tuned from the UV to the visible and infrared regimes depending on the nanorod aspect ratio, or the ratio of the length to width of the nanorod. In some embodiments, pixels composed of nanorods may include nanorods with aspect ratios equal to or between 1 and 5. In some embodiments, groups of these nanorods are arranged to create a pixel. In some embodiments, the spacing between the individual nanostructures within one pixel is large enough to avoid interparticle coupling, such as but not limited to having a period of the 2D arrays on the order of 2-3 times the average size of the nanoparticles making up an individual plasmonic pixel. In some embodiments, a period between nanoparticles of the array of nanoparticles in a specified direction may be 2-3 times the average nanoparticle size along the same direction. In some embodiments, the distance between nanoparticles along their length or a vertical period may be 2-3 times the average nanoparticle length. In some embodiments, the distance between nanoparticles along their width or horizontal period may be 2-3 times the average nanoparticle width. In 3D embodiments, the separation the distance between nanoparticles in different layers or a layer period may be 2-3 times the average nanoparticle height.

In some embodiments, the color of plasmonic pixels can be controlled by various methods, such as but not limited to the at least three methods outlined herein. First, the aspect ratio of the nanorods can determine the wavelength of maximum intensity of that nanorod. For example, a group of one or more nanorods with the same aspect ratio can make a pixel of a single color. Second, nanorods of different aspect ratios can be arranged in one region to make a pixel that has a color, which may be a color that is unachievable via a certain aspect ratio alone.

Third, far-field diffractive coupling that depends on the interparticle separation of the nanorods can modulate the observed color in addition to the nanorod aspect ratio.

In some embodiments, the excitation geometry of plasmonic particles can be used for color tuning. For instance, in some embodiments, the excitation geometry of plasmonic particles can be used to change the apparent color. Possible excitation geometries include standard reflected and transmitted light, reflected light in a dark-field geometry (high incidence angle excitation), and excitation via an evanescent field through total internal reflection, where the supporting glass substrate can act as an optical waveguide. Control over incident and scattered light polarization allows color tuning by taking advantage of far-field diffractive plasmon coupling.

Various methods may also be utilized to control the intensity of plasmonic pixels. For instance, in some embodiments, the intensity of plasmonic pixels are controlled in at least four ways: nanorod size, the plasmonic pixel's nanorod density, the intensity of the white light that is incident on the nanorods, and/or appropriate tuning of the collective far-field coupling peak.

In some embodiments, the overall size of the nanorod contributes directly to the intensity scattered from the nanorod. For example, larger nanorods of the same aspect ratio can be brighter. Separately, a pixel that contains more nanorods in the same area can also be brighter. Additionally, white light can strike the plasmonic pixel, causing the aluminum nanorods to scatter colored light. The brighter the incident light, the stronger and more intense the scattering. Further, tuning of the period of the array in the x and y direction yields different intensity peaks up to a maximum intensity for each plasmonic pixel. The size of the plasmonic pixel, limited only by the active switching mechanism applied to it, can be as small as a single nanorod or as large and with as many nanorods as new fabrication methods allow. In some embodiments, the size of the pixel may be 1.5×1.5 mm or smaller. In some embodiments, the size of the pixel may be 5×5 micron or smaller. In some embodiments, the size of the pixel may be 3×3 micron or smaller. In some embodiments, the size of the pixel may be 1×1 micron or smaller. In some embodiments, the size of the pixel may be in a nanoscale range. In some embodiments, the size of the pixel may be as small as 40×60 nm.

In some embodiments, the polarization of the light scattered from the plasmonic pixels can be controlled by the orientation of the nanorods making up the plasmonic pixel, where the scattered light is parallel to the long axis of the nanorod. A plasmonic pixel can scatter at a single polarization if all the nanorods are aligned parallel to one another, or the pixel can scatter a mix of polarizations controlled by the distribution of nanorod orientations within one plasmonic pixel. Different plasmonic pixels can be arranged in such a way that each plasmonic pixel has a certain single polarization direction. Further, this direction can vary from plasmonic pixel to plasmonic pixel. Similarly, the different plasmonic pixels arranged into a larger area can vary in terms of their color and intensity.

In some embodiments, nanoparticles in plasmonic pixels may have different shapes that could be used instead or in combination with nanorods. For shapes other than disks or spheres, the color of the plasmonic pixels due to scattered light may be dependent on the incident light polarization or, for unpolarized incident light, scatter only a certain polarization component of the incident light depending on the nature of the plasmon modes supported by a certain nanostructure shape and size.

In some embodiments, the plasmonic pixels are arranged in a way that they can be addressed individually, such a collection of plasmonic pixels can form a color image, which may be controlled through modulating the intensity of each plasmonic pixel by various methods. Such methods include, but are not limited to, liquid crystal filters that block and transmit scattered light as a function of the light polarization, taking advantage of the shape of the constituent nanoparticles and hence large polarization contrast of a plasmonic pixel. Other methods include modulation of incident and reflected light intensities through thermochromic materials, which can be tuned from transparent to opaque through control of the local temperature. Although image formation in color displays based on plasmonic pixels can be achieved analogous to conventional RGB pixel technologies, image formation is not limited to existing strategies for modulating the incident/reflected light intensities of individually addressable pixels.

In some embodiments, the plasmonic pixels can be utilized for color display applications. In some embodiments, a device using this color pixel technology does not require a powered internal light source, such as a backlight, frontlight, or the like, and can be used with ambient light or other light sources. In some embodiments, a device may be paired with an optional internal light source for viewing in a wider range of ambient light conditions.

In some embodiments, the following nonlimiting aspects of the plasmonic pixels are novel: the plasmonic pixels are novel in their use of aluminum nanorods as an optical element, arrangement of aluminum nanorods into a pixel for display purposes, ability to provide colored light without the aid of an applied electric current or color filters, and use of a plasmonic metal (e.g. aluminum) that is both cost effective and CMOS compatible.

In some embodiments, the following aspects of the plasmonic pixels provide numerous advantages: the plasmonic pixels have an advantage in that the flexibility of the substrate does not hinder the nanorods' ability to scatter colored light, of nearly arbitrary pixel size (e.g. a single pixel could provide a single nanorod of tens of nanometers), of an arbitrarily large array of nanorods, and of improving upon current display technologies by reducing the size of a single pixel to the diffraction limit of light. In some embodiments, the plasmonic pixels have the advantage in that the size of a working, active pixel is limited only by the switching technology. As such, the plasmonic pixels are already capable of achieving sizes smaller than the current active elements in display technologies. In some embodiments, the plasmonic pixels improve upon current display technologies because the nanorods are tens of nanometers thin, and therefore contribute no thickness to a viewing screen. In some embodiments, the nanoparticles or nanorods may be equal to or between 10 nm to 50 nm thick. In some embodiments, the thickness of the display is equal or less than approximately 0.1 mm thick, where the thickness of the display includes the thickness of the plasmonic pixels. Therefore, it is apparent that the pixels do not significantly contribute to the thickness to a display. In some embodiments, the nanoparticles or nanorods may be equal to or less than 50 nm thick. In some embodiments, the nanoparticles or nanorods may be equal to or less than 40 nm thick. In some embodiments, the nanoparticles or nanorods may be equal to or less than 30 nm thick. In some embodiments, the nanoparticles or nanorods may be equal to or less than 20 nm thick. In some embodiments, the nanoparticles or nanorods may be equal to or less than 10 nm thick.

In some embodiments, the plasmonic pixels have the advantage of arbitrary color control. For example, the plasmonic pixels could be operated using typical RGB values or could be paired with new active-switching technologies to incorporate more complicated pixel structures. In some embodiments, the plasmonic pixels improve upon other plasmonic metals in that their scattering wavelengths exist in the visible spectrum, even with substrates and surrounding media of high refractive indices. This makes aluminum even more uniquely suited to display applications. In some embodiments, the tenability of the plasmonic pixels allow for the wavelength extension of displays to the infrared and terahertz regimes.

In some embodiments, Aluminum nanorods for the plasmonic pixels can be prepared by electron beam lithography techniques. The nanorod dimensions, orientation, and position are determined during the patterning process, and the aluminum is deposited in an electron beam evaporator. In other embodiments, another suitable method for plasmonic pixel fabrication may be utilized, such as but not limited to chemical, lithographical, or other methods that are capable of producing plasmonic structures. In some embodiments, the plasmonic pixels can be prepared of any suitable plasmonic material. Nonlimiting examples include aluminum, gold, silver, combinations thereof, or the like. Notably, changing the plasmonic material can change the achievable plasmonic resonances, allowing pixels with ‘color’ spanning the UV, visible, infrared, and terahertz.

In various embodiments, the plasmonic pixels can be prepared using any plasmonic structure, including, but not limited to, nanorods, nanoshells, nanoparticles, spiky shells, cubes, triangles, prisms, disks, nanowires, gratings, Fano structures, and/or other single or coupled nano structures. Coupling between particles can shift the plasmon resonance and could also be used as a tool for tuning the properties of the plasmonic pixel. In various embodiments, control over the polarization of the scattered light is optional in these pixels, though differently polarized excitation conditions will produce pixels of different colors. Nanostructures which are highly symmetric scatter unpolarized light, as will be the result of a pixel with many different nanorod orientations. In various embodiments, the plasmonic pixels could be paired with any current or future liquid crystal display technologies. This pairing could remove the desire for backlighting, color filters, and the rear polarization filter on LCD screens. In some embodiments, plasmonic pixels could be paired with thermochromic active elements to produce color on-off or color/color switching. These active elements could be actively powered or could respond to temperature changes in the environment. In some embodiments, the devices may include an additional light source for operation at in certain light levels.

Diffractive coupling can be used to sufficiently narrow and enhance the plasmon response of aluminum nanorods, allowing them to produce vibrant, strongly polarized red, green, and blue colors for additive color displays. The enhanced spectra, tunable peak position, and strong polarization characteristics of these pixels make them immediately compatible with active display technology, such as liquid crystal displays (LCDs), without the need for color filters or multiple polarizers.

Aluminum nanorods in a 2D array scatter well defined, polarized, and highly tunable colors for RGB full color displays. In particular, red, green, and blue pixels may be made from aluminum nanorods in ordered 2D arrays. Tuning of the nanorod length, and the x and y period within the array can produce sharp spectral peaks never before seen in aluminum nanoparticles under dark field scattering conditions. The fabrication techniques, vivid colors, and highly polarized response make these pixels an excellent candidate for rapid introduction into current display technology.

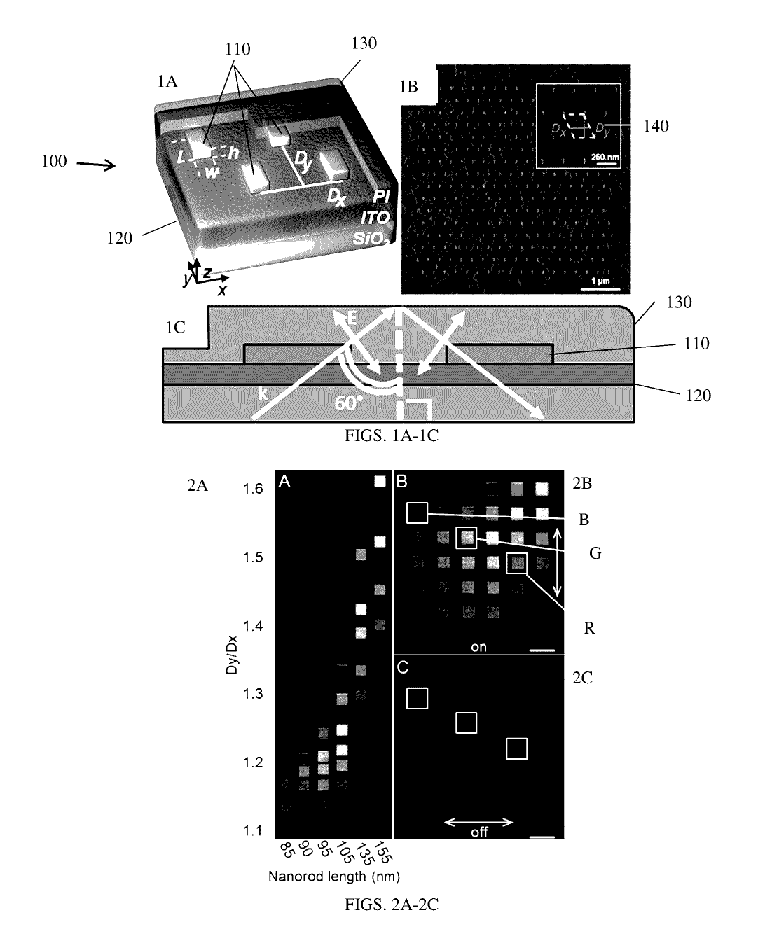

FIGS. 1A-1C respectively show a schematic of a pixel 100, SEM image of a pixel, and cross-section of a pixel. The plasmonic pixels 100 described herein are composed of co-oriented nanoparticles or nanorods 110 that fit within an arbitrarily chosen footprint (e.g. 5 microns square). In other embodiments, pixels could conceivably be as large or as small as the application warrants. In some embodiments, all nanorods in a pixel have the same length (l), width (w), and height (h). The pixels may have well-defined periods along the vertical (D_{y}) and horizontal (Dₓ) directions, where D_{y} represents a vertical separation distance between nanoparticles 110 and Dₓ represents a horizontal separation distance between nanoparticles. As a nonlimiting example, Aluminum nanorods 110 may be positioned on a substrate 120, such as a SiO₂ substrate coated with ITO, silicon substrate, SiO₂ substrate with any suitable thin-film semiconductor layer, SiO₂ substrate, SiO₂ substrate coated with a layer of aluminum, various smooth plastic substrates, or the like. and the nanorods 110 may be overcoated with a top layer 130, such as polyimide, SiO₂, or any suitable layer with a refractive index of approximately 1.5 to 1.7. In some embodiments, the nanorods may be arranged in any suitable regular arrangement 140. In some embodiments, the regular arrangement may have interparticle distances equal to or between 150 nm to 400 nm. As a nonlimiting example, the regular arrangement 140 of nanoparticles may be selected from an approximately hexagonal array (e.g. FIG. 1B), rectangular array, or a square array so that the light rays diffracted from the nanoparticle array can maximally interfere with one another in the far field. In some embodiments, a suitable array 140 arrangement may be defined by a trapezoid with pixels at each corner of the trapezoid. In some embodiments, the trapezoid may be defined by a length Dₓ and height D_{y}, which also represent the horizontal and vertical period between the nanoparticles. FIG. 1B shows the physical layout in the xy plane of a sample pixel. As a nonlimiting example, the 5 micron square plasmonic pixel has the following parameters: l=80 nm, w=40 nm, h=35 nm, Dₓ=270 nm, and Dy=120 nm. The inset shows a high magnification image of the lower right corner, with a marker bar of 250 nm. The physical parameters of the single nanorods produce a spectral resonance in the far field that is dominated by the longitudinal surface plasmon resonance, or LSPR. Their placement in an array enhances the plasmon resonance by shifting the peak position, narrowing the lineshape, and increasing the intensity of the plasmon resonance, all of which are due to the same diffractive coupling.

As a nonlimiting example, the pixels may be prepared via standard electron beam lithography on an indium tin oxide (ITO) coated glass substrate (SiO₂), and overcoated with a layer of polyimide (PI). All nanorods in a pixel may have identical length l, width w, height h, and orientation parallel to the y axis. As a nonlimiting example, the nanorods shown have the same length of 80 nm, width of 40 nm and height of 35 nm. Within the nearly hexagonal array of nanorods, the period between nanorods in the x direction is Dₓ and the period along the y direction is D_{y}. The finished pixel sample is coated with PI. As shown in FIG. 1C, pixels may be excited by p-polarized light with the k vector propagating (and E-field oscillating) in the yz plane.

The polyimide layer may serve several purposes. First, although the aluminum forms its own approximately 3 nm, self-terminating oxide layer rapidly after evaporation, the polyimide acts as a second line of defense against further oxidation. Second, the polyimide creates an environment around the pixels that is roughly one average refractive index, which improves the grating response by allowing more effective coherent coupling between particles. Third, the polyimide controls the position of the surface at which total internal reflection occurs, so that the pixels are excited by incident light at 60° relative to z along the yz plane. The excitation light is then totally internally reflected so as not to be detected, which causes these pixels to have incredibly low background (e.g. FIGS. 2A-2C). Only the signal from the pixels, not the excitation light, has a propagation vector near enough to normal that it can travel through the interface.

The following examples are included to demonstrate particular aspects of the present disclosure. It should be appreciated by those of ordinary skill in the art that the methods described in the examples that follow merely represent illustrative embodiments of the disclosure. Those of ordinary skill in the art should, in light of the present disclosure, appreciate that many changes can be made in the specific embodiments described and still obtain a like or similar result without departing from the spirit and scope of the present disclosure.

The color of pixels, as mentioned earlier, is controlled by the physical parameters selected. In some embodiments, the ratio of D_{y}/Dₓ may be equal to or between 1 to 2 to strongly enhance the plasmon resonance. According to FIG. 2A, which is a composite image with the pixels plotted according to their D_{y}/Dₓ and the nanorod lengths for each pixel, the value of this ratio clearly contributes to color control beyond what is possible with nanorod aspect ratio alone. Dark field (total internal reflection) SLR images of aluminum pixels are shown in FIGS. 2A-2C. FIG. 2A shows composite SLR image where the image of each 5 micron pixel is positioned according to its period ratio, D_{y}/Dₓ and the nanorod length 1. Seven different D_{y}/Dₓ were prepared for each l, though six pixels were omitted because of space considerations without loss of information. FIG. 2B shows a polarized image for pixels in FIG. 2A showing the as-designed layout, with no pixels omitted. The polarizer was placed in the detection path parallel to the y axis, showing the “on” state of the pixels. The highlighted pixels shown in white boxes were selected as the best red, green, and blue color in this pixel array. FIG. 2C shows an image of the same region as in FIG. 2B, with the polarizer parallel to the x axis, showing the “off” state of the pixels. Both images were taken with ISO 100, 10s exposure.

Inspection of FIG. 2A shows that, within a single nanorod length, smaller values for D_{y}/Dₓ redshift the color toward reds and browns, while larger values shift the color toward blues and greens. Separately, for a single D_{y}/Dₓ, longer nanorods cause the color to redshift while shorter nanorods cause the color to blueshift. Contributions to the pixel intensity include the physical size of the nanorods within the pixel, an appropriate match between the ratio Dy/Dx and the nanorod plasmon resonance, and most likely appropriate specific values for D_{y} and Dₓ.

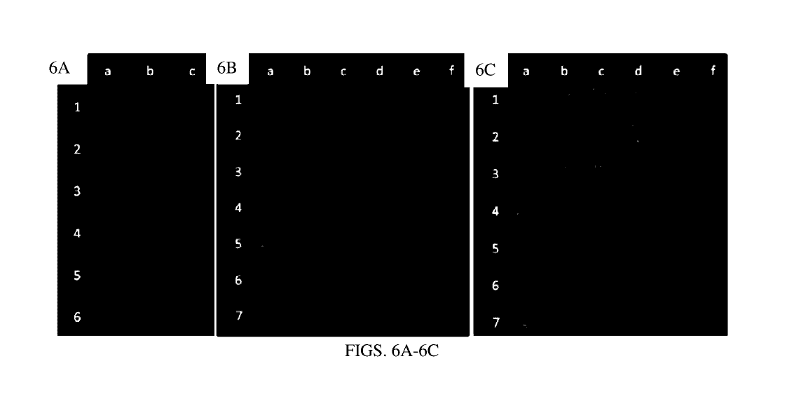

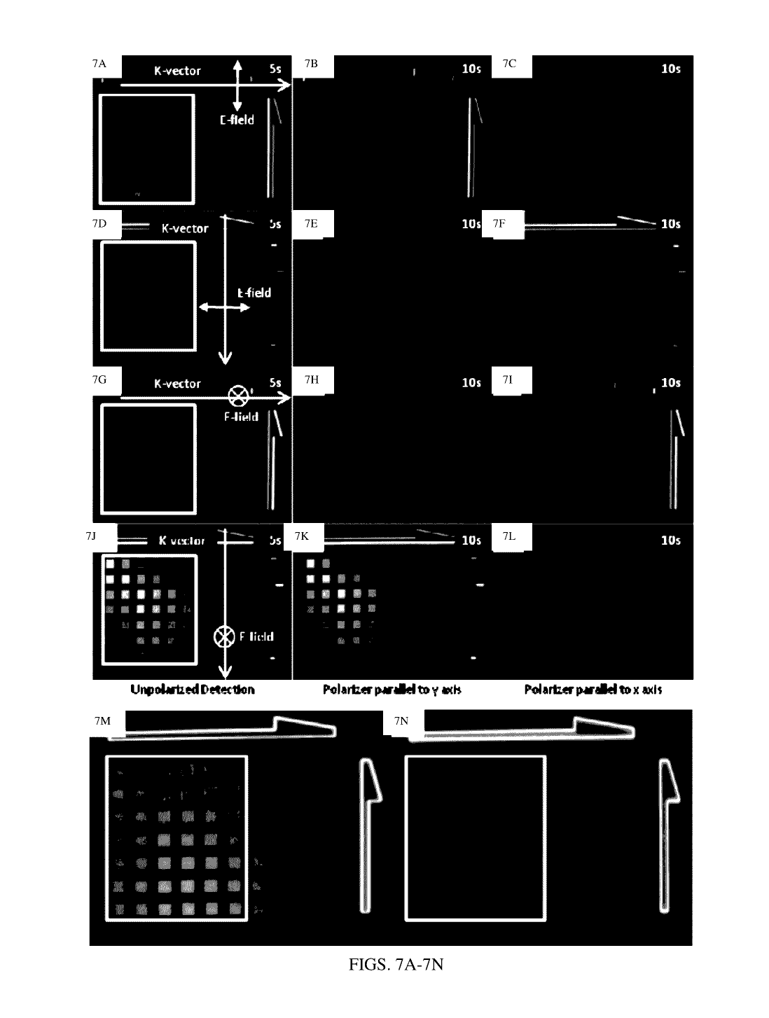

While optimization of each of these parameters could yield improved intensities and linewidths for pixels, note that such perfectly optimized values are not necessary in order to achieve optimal results. Other D_{y} and Dₓ values, as well as pixels with random nanorod placement did not yield such uniform and vivid colors (FIGS. 6A-6C). Additionally, other excitation geometries were investigated with different results=(FIG. 7A-7N).

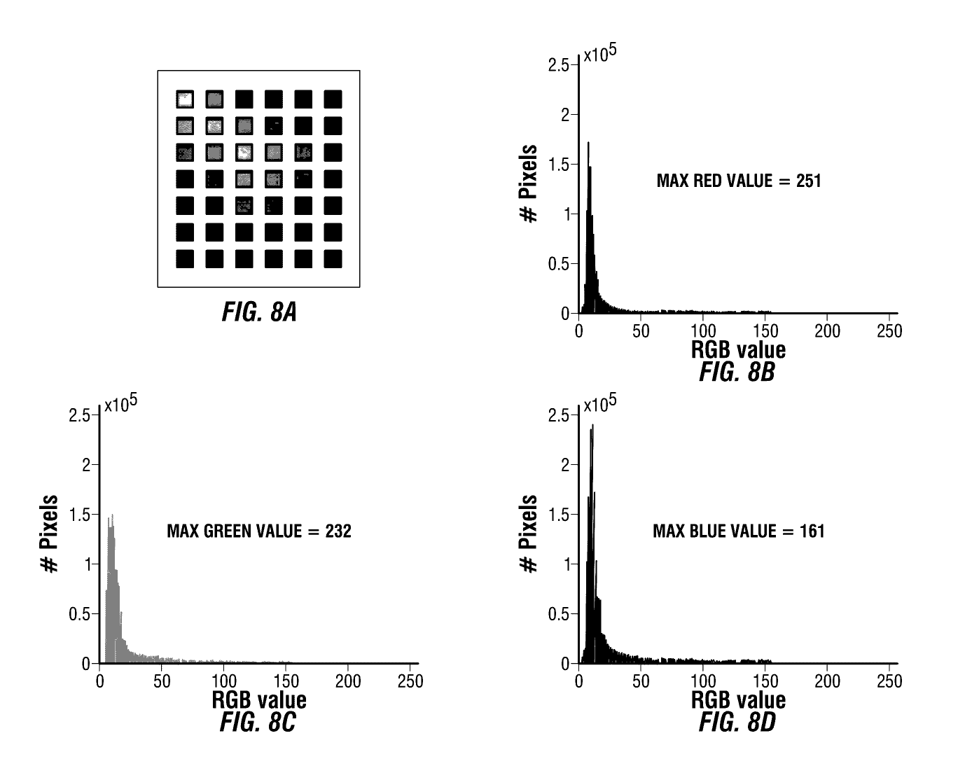

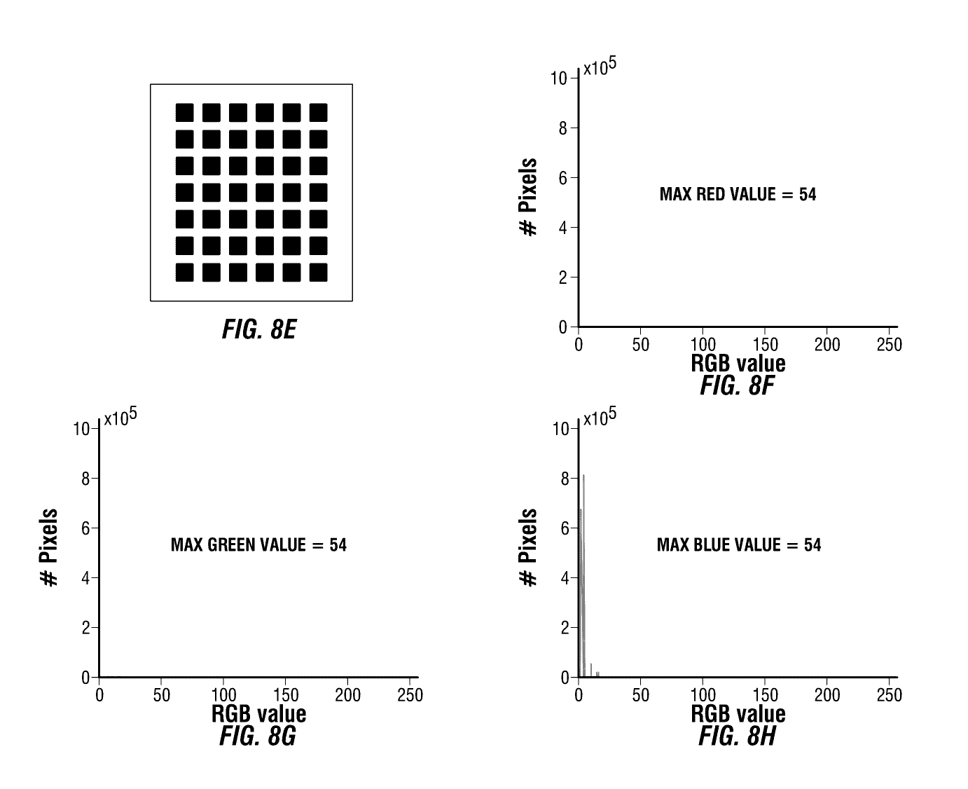

In addition to vivid color and wide tunability, these pixels are also highly polarized. A comparison of FIGS. 2B and 2C (which have identical exposure times) show that the on state and off state of the pixels can be selected for by using a polarization filter on the detection path. In this example, the polarizer is placed parallel to the y axis (FIG. 2B, on state), and then parallel to the x axis (FIG. 2C, off state). It is important to note that the exposure times for FIGS. 2B-2C were chosen specifically because some pixels were near to saturation, but not saturated, in at least one color channel (image in FIG. 2B). Using the same settings, however, the signal in from the off state (FIG. 2C) is essentially at the noise threshold of the camera. FIG. 8A-8H demonstrates this fact. Three pixels from this sample, highlighted in white boxes, were selected for further study.

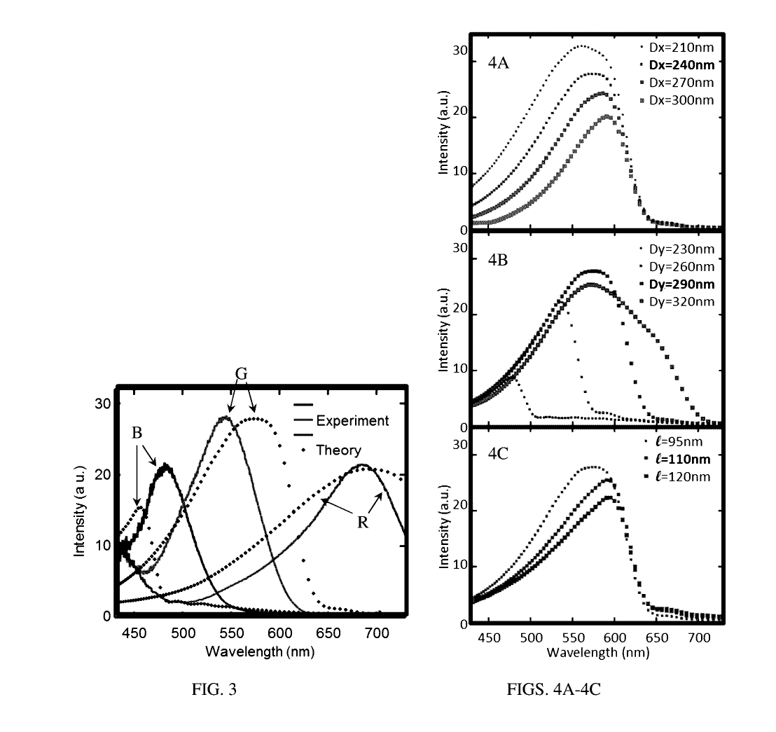

FIG. 3 shows the experimental spectra (with no polarized detection) of the highlighted pixels (solid lines) and the theoretical spectra for the same physical parameters (black dotted lines). The spectra for each of the three highlighted pixels is shown in the visible range of the spectrum. The solid lines show the experimental spectra and the dotted lines are theoretical calculations for pixels with the same parameters (FIG. 8A-8H shows a comparison to the LEDs on a typical display). The sRGB color of the three solid lines were calculated from each spectrum using the CIE 1931 standard observer and converting from XYZ color coordinates to sRGB, and are: [0.8034/1, 0.1663/1, 0.2361/1] (red), [0.0281/1, 0.6778/1, 0.1447/1] (green), and [0/1, 0.2779/1, 0.6571/1] (blue). The linewidths are significantly narrower for similar peak positions in single nanorods, due to the diffractive coupling, which sharpens the peak. These three spectra are shown at their relative intensities.

FIGS. 4A-4C shows how independently varying each of the three parameters that describe a pixel can affect the spectrum of the pixel. Using the same theoretical methods as for FIG. 3, a standard pixel (length=l, D_{y}, and Dₓ) is plotted in each panel, along with four other variations on Dₓ (FIG. 4A), Dy (FIG. 4B), and length (FIG. 4C). Comparing these three panels, D_{y} appears to have the most control over peak position and intensity (FIG. 4B). Without being bound by theory, it is envisioned that such results are obtained because the longitudinal plasmon resonance that oscillates parallel to the nanorod long axis most strongly couples to its neighbors. On the other hand, variations in Dₓ (FIG. 4A) and length (FIG. 4C) seem to have a similar effect on the peak position and linewidth. Theoretical calculation of pixel spectra with each of the three parameters varied individually, using the spectrum of the representative green pixel as a starting point. (FIG. 4A) Four pixel spectra with l of 95 nm, D_{y} of 290 nm, and Dₓ of 210 nm (linewidth 1), 240 nm (linewidth 2), 270 nm (linewidth 3), and 300 nm (linewidth 4). (FIG. 4B) Four pixel spectra with 1 of 95 nm, Dₓ of 240 nm, and D_{y} of 230 nm (linewidth 1), 260 nm (linewidth 2), 290 nm (linewidth 3), and 320 nm (linewidth 4). (FIG. 4C) Four pixel spectra with Dₓ of 240 nm, D_{y} of 290 nm, and l of 80 nm (linewidth 1), 95 nm (linewidth 2), 110 nm (linewidth 3), and 120 nm (linewidth 4). The bold notation in the three graphs indicate that this spectrum (same in all three) is also the same as calculated for the representative green pixel. Each of the spectra has been plotted using the sRGB value calculated from the spectrum using the CIE 1931 standard observer in the same way as was done for experimental spectra in FIG. 3.

As a whole, this example demonstrates that aluminum plasmonic pixels are capable of producing red green and blue color compatible with RGB additive color schemes. It is an appropriate combination of all three physical parameters, nanorod length, Dₓ, and D_{y}, which allows for achieving vivid colors with sharp peaks. Additionally, the use of nanorods as the basic component of these pixels causes the color to be strongly polarized. Although the standard electron beam lithography methods used are not easily scalable to industrial requirements, nanorods of similar sizes can be produced by other scalable methods, such as extreme UV lithography which utilizes an interference mask and coherent light source and otherwise standard lithography techniques, nanoimprint lithography which utilizes a reusable stamp to pattern whole pixels at once, or any other suitable lithography methods. The plasmonic pixels provide a combination of vibrant and highly tunable colors, highly polarized signal, and potential scalability.

Materials and Methods:

A clean glass slide coated with ITO (8-12 ohm sheet resistance, Delta Technologies LTD) was spin coated with a positive electron beam resist (a 50/50 mixture of PMMA 495 A4 and A2, MicroChem) and baked at 180° C. for 90 seconds. After patterning (JEOL 6500F SEM equipped with beam blanker and associated with Nabity NPGS software) and development, 35 nm of aluminum was evaporated onto the substrate at a base pressure of ˜2×10-7 torr to promote low oxide content in the bulk aluminum (24). Liftoff included soaking the sample in acetone for 15 hours, followed by gentle rinsing with fresh acetone. Shorter soaking times resulted in nanorods with rough edges or pixels with missing regions. The substrate with aluminum structures was then spin coated with a polyimide solution (Nissan Chemical, SE-3510), and baked at 180° C. for 45 minutes.

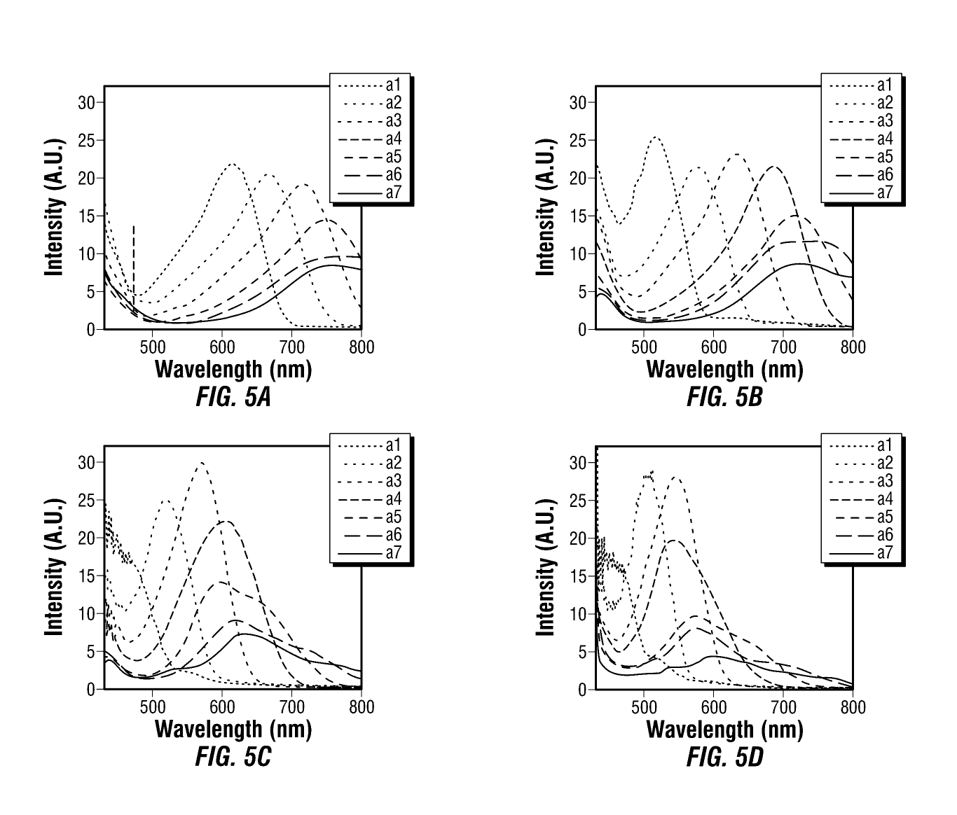

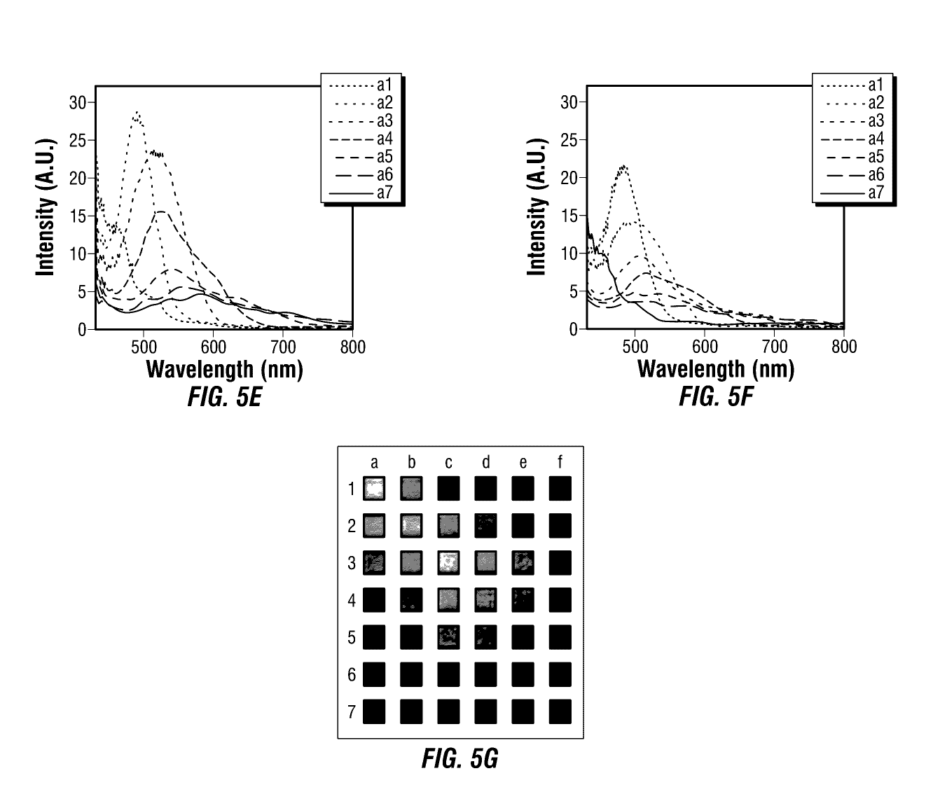

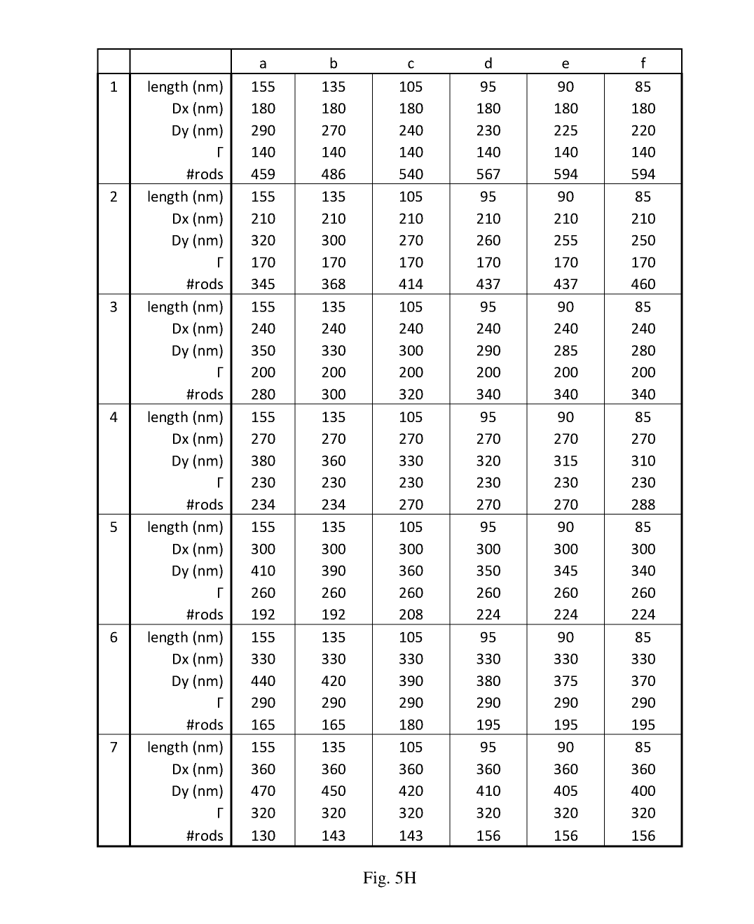

Individual pixels were designed to fit within a footprint of 5 microns by 5 microns, so that the number of nanorods in the x direction is 5000 nm/Dₓ and the number of rows in the y direction is 5000 nm/D_{y}. These numbers were rounded to the lowest whole number and used to prepare the design. Exact physical parameters for pixels presented are discussed further below (FIGS. 5A-5H).

The aluminum pixels were studied using SEM before polyimide coating (same as lithography, or FEI Quanta 400 SEM) and dark field microscopy after polyimide coating. For dark field images and spectra, the sample was placed on an inverted microscope (Zeiss, Axiovert 200) with glass substrate side up (pixel side down, toward the objective—50×, NA=0.8, Zeiss, HD DIC M27). A prism with top angle of 60° was used to couple white light from a tungsten lamp (Newport) into the sample. The lamp was mounted in a cage system (Thorlabs) which included a polarizer set to direct only p-polarized white light to the sample. Images were collected using a Canon Rebel DSLR camera with ISO set to 100 and various exposure times. Spectra were collected by passing the light from the pixel through a 50 μm pinhole at the image plane of the microscope to a spectrometer (Princeton instruments, Acton SP2150i) and CCD camera (Princeton Instruments, PIXIS 400BR).

FIGS. 5A-5F show a complete series of dark field spectra correlated to the pixels and their physical parameters. Seven pixels, with variable Dₓ and D_{y}, were prepared for each nanorod length, (FIG. 5A) 155 nm, (FIG. 5B) 135 nm, (FIG. 5C) 105 nm, (FIG. 5D) 95 nm, (FIG. 5E) 85 nm, and (FIG. 5F) 80 nm. These six series of spectra are taken from the similarly labeled columns in (FIG. 5G), such that pixel a7 in (FIG. 5G) corresponds to the thinnest linewidth spectrum in (FIG. 5A), and so on. The nanorod length Dₓ and D_{y} for each pixel in (FIG. 5G) is given in the table (FIG. 5H).

In addition to providing complete information on the samples presented, the spectra in FIGS. 4A-4F further illustrate that, for each nanorod length, appropriate choice of Dₓ and D_{y} can significantly enhance the plasmon resonance. For each nanorod length, there are several D_{y}/Dₓ values that yield sharp peaks, and all D_{y}/Dₓ values adjust the plasmon resonance for the same nanorod length. FIG. 5G corresponds to FIG. 2B, but is flipped horizontally to match the layout of the sample design schematic as presented in the table.

FIGS. 6A-6C show alternative sample arrangements. In addition to the sample design described above, some samples were also prepared that were not hexagonal arrays with well-defined Dₓ and D_{y}. For FIG. 6A, nanorods were randomly positioned according to Matlab code, which originated a square array and subsequently randomly perturbed the nanorods in the x and y direction. The random displacement of these nanorods was confined so that they would not be placed near enough for near-field coupling to occur. Similar nanorod densities were prepared in this sample as the approximate densities provided above. The nanorod lengths are the same in the vertical columns: a=155 nm, b=135 nm, and c=105 nm. Nanorod densities are the same across a row, so that in a 5 micron×5 micron, the same square array of nanorods was randomly perturbed: 1=12×12 (144 nanorods), 2=14×14 (196 nanorods), 3=15×15 (225 nanorods), 4=17×17 (289 nanorods), 5=18×18 (324 nanorods), and 6=20×20 (400 nanorods). (FIG. 6B) Roughly 10% of the nanorods in an otherwise hexagonal array were displaced by hand in the Design card software from an otherwise hexagonal array of nanorods of the same layout as FIG. 5A-5F. (FIG. 6C) Values of D_{y} were varied (row 1=300 nm, with increments of 50 nm as row number increases) while Dₓ was kept constant at 300 nm. Nanorod length for all columns a-f is the same as described for FIG. 6B and FIG. 5G table.

FIGS. 6A-6B demonstrate that it is the diffractive coupling of the array structure which enhances the plasmon resonance of these pixels, and random perturbations disrupt those oscillations. In FIG. 6A, nanorods were placed at random positions within a 5 micron by 5 micron footprint, but even so, column a contains all the same aspect ratio of nanorods, and still the color changes significantly from the top of the column (sparsely packed nanorods providing red color) to the bottom of the column (densely packed nanorods providing blue color), albeit with a mosaic pattern of defect like points across the face of each pixel. Therefore, the effect of diffractive coupling cannot be avoided or ignored by random position of the nanorods in order to break up the coherent oscillations across the pixel. Similarly, introducing fewer defects into the sample has a similar effect of adding a mosaic pattern to the pixels (FIG. 6B).

Additionally, FIG. 6C emphasizes the point that it is an appropriate combination of Dₓ and D_{y}, not simply the “right” value in either one parameter, which yields the best enhancements to the nanorod plasmon resonance. In this figure, the columns represent same length of nanorods, while each row represents the same value of D_{y} (Dₓ is kept constant at 300 nm in this sample). Although some of the colors seem to become slightly more intense, none of the colors are as immensely bright as are presented previously above. It is concluded that although D_{y} appears to be one of the strongest parameters in the control over the color in a pixel, all parameters work together in a somewhat synergistic way to create the enhanced plasmon resonances that provide our vibrant RGB colors.

FIGS. 7A-7N show additional excitation geometries for the same sample, in comparison to the excitation discussed previously above. The pixels are shown “as designed”, with alignment marker arrows, which are also made of aluminum. The white boxes in several of the images indicate the region that was discussed above. For each series of three images, the excitation geometry with the same prism excitation described in the materials and method is used. FIGS. 7A-7C show the pixel array with s-polarized light that is parallel to the y axis (nanorod long axis within the pixel array), with no polarizer in the detection (FIG. 7A), or polarizer parallel to the y axis (FIG. 7B) or x axis (FIG. 7C). FIGS. 7D-7C show the same with s-polarized light that is polarized parallel to the x direction. FIGS. 7G-7I show the same with p-polarized light, polarized in the xz plane. FIGS. 7J-7L show the same for light polarized along the yz plane, which is the same as discussed above. The exposure time for each image is noted in the top right corner of each image (FIGS. 7A-7L). Additionally, the same array of pixels was imaged under dark field illumination via a dark field condenser (FIG. 7M), where the excitation light was unpolarized and excited the pixels from many directions. The sample was also imaged under reflection dark field illuminations (FIG. 7N). All images were taken using the same 50× objective, NA=0.8 (Zeiss) and SLR camera.

There was clearly a significant difference in the color of the same array of pixels depending on the direction and polarization of the illumination source. The first three rows in FIGS. 7A-7C are very dim compared to FIGS. 7J-7L, which are taken at the same exposure times and under identical excitation intensity. FIG. 7K and FIG. 7L are the same as shown (cropped, but not otherwise edited) previously.

A further example that the excitation geometry has a significant effect on the observed color of the pixels is in FIG. 7M, where a dark field condenser was used instead of prism-coupled dark field, with a polarizer in the detection path allowing y-polarized signal to pass. The polarization of the excitation light is unpolarized in this excitation geometry, and the pixels are excited at approximately a 70° angle from all sides in the xy plane. Compared to FIG. 7K, the color of the pixels was completely different, though clearly there is some relationship between the physical parameters and the color of the pixels.

When the pixels are viewed under reflection dark field geometry (FIG. 7N), yet again different colors were seen of the pixels (using the same objective, and with a drop of oil on the top side of the sample to aid in reducing the background due to reflected excitation light). Interestingly, a close inspection of the dim signal in (FIG. 7N) reveals that the vertical columns (all the same length of nanorod) are nearly the same color, which is not the case in any of the other excitation geometries. This observation indicates that, under these excitation conditions, it may be the nanorod aspect ratio that is the strongest contributor to the color of the pixel, with little dependence on Dₓ or D_{y}.

FIGS. 8A-8H show analysis of RGB levels associated with FIGS. 2A-2C. FIG. 8A shows the aluminum pixels in the on-state, with the polarizer parallel to the y axis (vertical in this image). The color values from the image were loaded into Matlab, and the (FIG. 8B) red, (FIG. 8C) green, and (FIG. 8D) blue values from FIG. 8A are shown in histograms, where the number of pixels (vertical axis) with a certain color saturation value (horizontal axis) are plotted. Some pixels in 8A are nearly saturated, but no pixel completely reaches 255/255 in any of the three histograms. Alternatively, under the same imaging conditions, (FIG. 8E) the signal associated with the off-state of the pixels (polarizer parallel to the x axis, horizontal in this image) is just above the noise level of the camera. The inset of FIG. 8E shows the same image as FIG. 8E, but with the colors thresholded so that “full color range” would be reached at a pixel value of 5 or higher, rather than 255. Even so, the pixels are gray, nearly black in all regions. FIGS. 8F-H show similar histograms for FIG. 8E.

FIGS. 8A-8H provide a quantitative idea of how completely the signal from these pixels can be turned on and off under the excitation conditions presented above. FIG. 8A and the three associated histograms show that, although much of the image is dark (low background), some of the pixels are near to saturation of their color values. Therefore, longer exposure times would have oversaturated the color channels at those pixels and provided less accurate images. Even so, at the same excitation and imaging conditions, the most of the signal in the off state image is between 1 and 5 out of a 255 value color rage for red, green, and blue. The inset of FIG. 8E and its three histograms show that these values are barely above the noise threshold for the SLR camera used to take these images.

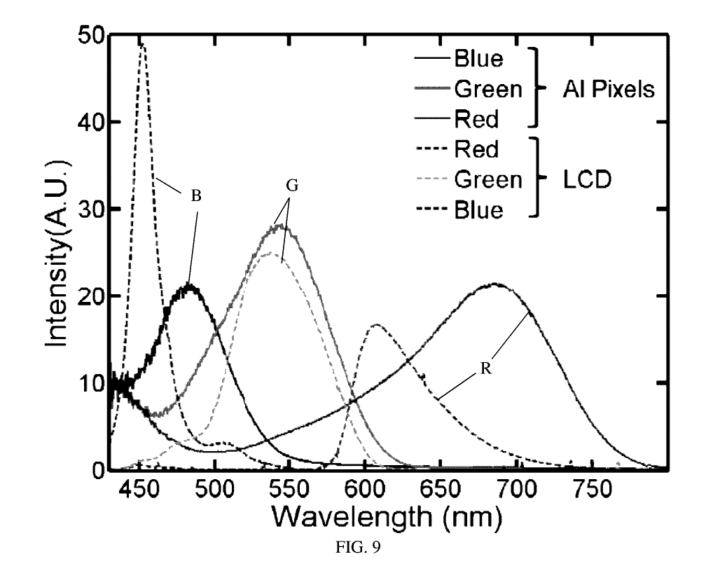

FIG. 9 shows a comparison between spectra of plasmonic pixels and a commercial LCD display. The same experimental spectra from FIG. 3 (representative red, green, and blue pixels) are plotted on the same axes as red green and blue pixels from a commercial color display. A smart phone was used to show how comparable our aluminum plasmonic pixels are against current LED/LCD technology on the market. A Droid DNA from HTC was used, in conjunction with the free version of the app “Display Tester” to set all pixels on the screen to red, green, or blue at once. The smartphone display is a 5-inch 1080×1920 (441 pixels per inch) Super LCD 3 display, which uses backlighting consisting of LEDs. With the phone display set to a color, a spectrum was taken. A “background” was subtracted from each color spectrum, where all pixels were set to black, because some of the phone buttons continued to display some light during all pixel color settings which were picked up by the detector. The corrected spectra from the smartphone (dotted lines) were scaled down to comparable intensities and are shown overlaid with the spectra from the aluminum pixels (solid lines). In both the pixel spectra and the LCD spectra, the data are plotted in the sRGB colors calculated from the spectra using the CIE 1931 standard observer. The smartphone spectra were scaled down because they are the sum of many pixels, while the aluminum pixel spectra are from a single 5 micron pixel, composed of a few hundred nanorods.

The spectra of the aluminum pixels yields similar sRGB colors to the LED pixels, and the green spectra are extremely similar. The green aluminum pixel is extremely similar to the green LED color, and only has a slightly larger linewidth than the LED spectrum. The blue aluminum pixel is both slightly reshifted and far dimmer (relative to the green pixel) than is the blue LED. The red aluminum pixel is the most different from its smartphone counterpart. Where the aluminum pixel has a peak near 700 nm, a tail towards orange, and a small rise toward the UV, the LED pixel has a slightly sharper peak at about 610 nm and a tail towards the IR. Both shapes, however, maximize the integrated intensity in the range between 630 nm and 700 nm, which is the largest contributing region to the red color. sRGB values were calculated according to CIE 1931 standard observer, standard in display technology, which was downloaded in Excel format from: http://www.cie.co.at/index.php/LEFTMENUE/index.php?i_ca_id=298. This file contains a matrix of four columns of data: the wavelength, and the “sensitivity” for the red, green, and blue channels. A Matlab function was prepared that would load the standard observer spectra and the sample spectrum, and then bin the sample spectrum to match the observer spectrum wavelength values. The newly binned sample spectrum was the multiplied against each of the red, green, and blue spectra, which essentially scales the spectrum according to the “sensitivity” of the observer at each wavelength. The resulting intensity vector for each of the “x”, “y”, and “z” spectra were then summed and normalized to obtain a color value in xyz color space: [X Y Z], where none of the three parameters was larger than 1. To convert from xyz color space to sRGB, the following 3×3 conversion matrix was obtained from http://www.cs.rit.edu/˜ncs/color/t_convert.html#RGB.

### M=[3.240479, −1.537150, −0.498535;

−0.969256, 1.875992, 0.041556;
0.055648, −0.204043, 1.057311];

$$So that [ \begin{matrix}R \\ G \\ B\end{matrix} ] = M [ \begin{matrix}X \\ Y \\ Z\end{matrix} ] .$$

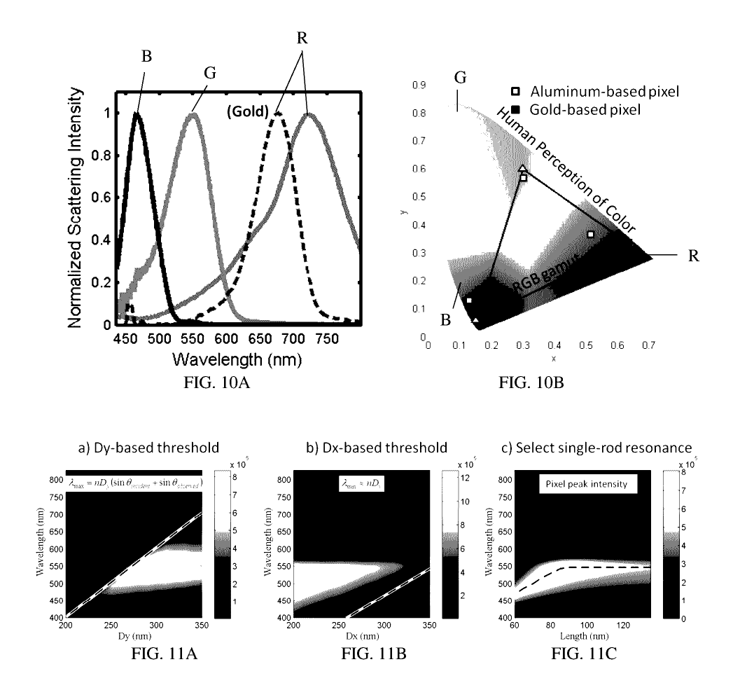

FIG. 10A-10B show extended color gamut for aluminum and gold plasmonic pixels. Spectra of each pixel (FIG. 10A) is convolved with the human eye sensitivity spectra to obtain the data points in FIG. 10B. The colored portion of the CIE diagram (FIG. 10B) represents colors the human eye can see, and the black-outlined triangular region represents the standard RGB color gamut (sRGB). The three white squares represent the aluminum plasmonic pixels that come closest to sRGB tristimulus values. Gold-based pixels are superior to aluminum in the generation of red color, and this has been demonstrated experimentally, as shown in the dashed-line spectrum in FIG. 10A and the black-filled square data point in FIG. 10B.

This shows that the color of the plasmonic pixels is comparable with current display technology. Also, that the design works for metals other than aluminum (including gold and similarly for any other suitable plasmonic metal).

TABLE 1
Physical parameters for pixels shown in FIGS. 10A-10B.

| | Width | Length | Dx | Dy |
|---|---|---|---|---|
| Red | 48 nm | 154 nm | 262 nm | 418 nm |
| Green | 43 nm | 88 nm | 278 nm | 278 nm |
| Blue | 40 nm | 95 nm | 128 nm | 238 nm |
| Au-Red | 30 nm | 56 nm | 336 nm | 346 nm |

Table 1 shows average values of the physical parameters for each spectrum/data point depicted in FIGS. 10A-10B as measured via SEM images. SEM images were taken using 100,000× magnification at a working distance of 10 mm with accelerating voltage of 30 keV. Nanorod to nanorod variation within a single sample is approximately 5% of the length or width of the nanorod, and ±5 nm for Dₓ and D_{y}. These variations are defined only for electron beam lithography on the instruments used for these samples. These are examples of the kind of physical parameters that would be used to make similar pixels, and other colors (or similar colors) can be made using different parameters.

FIGS. 11A-11C respectively show a Dy-based threshold, Dx-based threshold, and select single-rod resonance, which illustrates the theoretical basis for the design of a plasmonic pixel. The color of a pixel is determined by its physical characteristics. The broad, single nanorod plasmon lineshape can be restricted at long wavelengths by controlling the distance between nanorods along their lengths (variable D_{y}, FIG. 11A), according to the equation:

λₘₐₓ=nD_{y}(sin θ_{incident}+sin θ_{observed})

Shown in FIG. 11A, the nanorod length is set to 85 nm, Dₓ to 280 nm, and D_{y} is varied between 200 nm and 350 nm. Typically, the distance between nanorods along their widths (variable Dₓ, FIG. 11B) is similar to D_{y}, but adjustment of Dₓ to be larger or smaller controls the pixel color at shorter wavelengths. The darkest part of the spectrum near the dashed line follows a trend of approximately Dₓ times the refractive index. Shown in FIG. 11B, the nanorod length is set to 85 nm, D_{y} to 280 nm, and Dₓ is varied between 200 nm and 350 nm. In FIG. 11C, the precise peak position of the pixel is determined by the aspect ratio of the nanorod (or by the length, if the width is kept constant). For a 40 nm wide aluminum nanorod, the length was adjusted between 60 nm and 120 nm to show how the nanorod length controls the peak position within the boundaries set by the Dₓ and D_{y} based thresholds.

Notably in FIG. 11A, where the long-wavelength threshold is controlled, does not have to be dependent on an objective or other “detector” to induce the threshold. The polyimide or other material surrounding the pixels may be of a sufficiently high refractive index such that total internal reflection may be used to set the observation angle. With the polyimide used, this observation angle is approximately 37 degrees inside the polyimide.

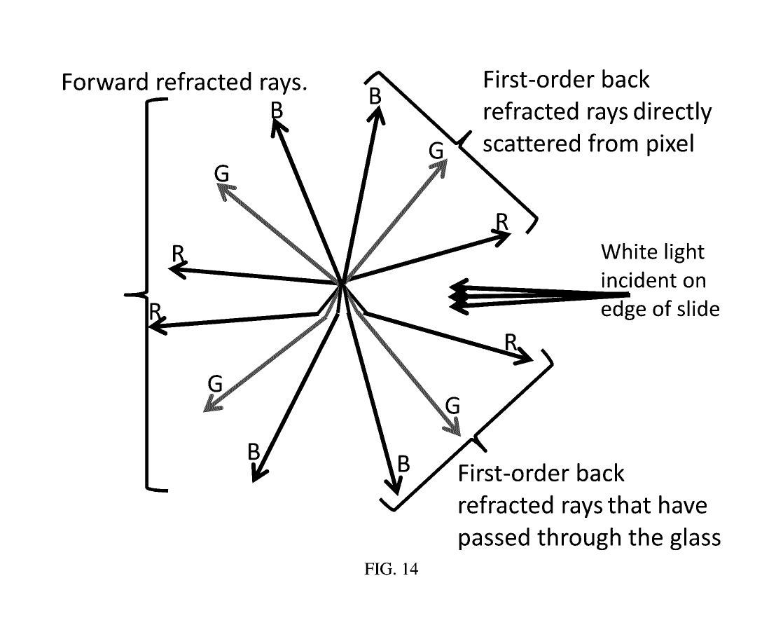

The same equation (for FIG. 11A) can also be interpreted so that λₘₐₓ is the wavelength which the observer would see if they observe the pixel by eye at angle θ_{observed} with no diffuser on top of the pixel. See FIGS. 13 and 14 for more information.

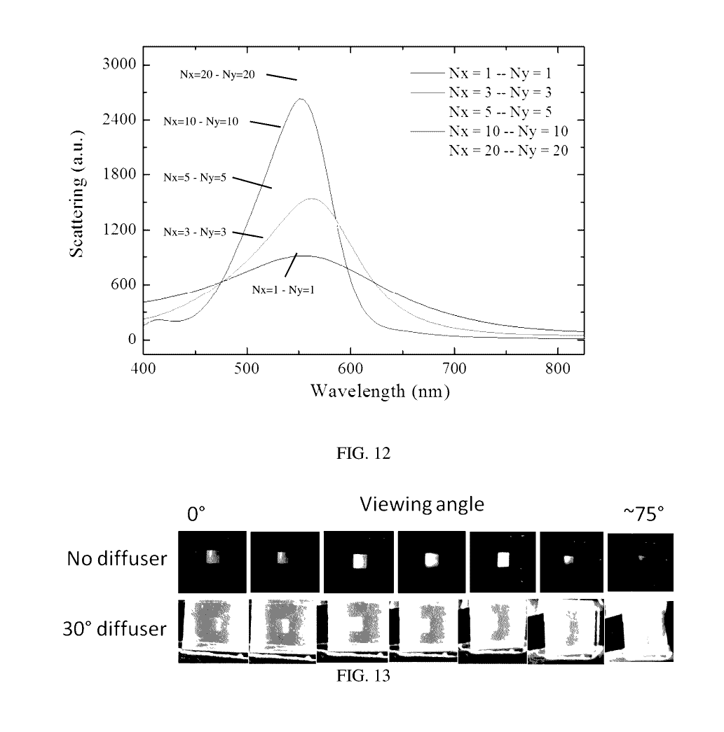

FIG. 12 shows the calculated scattering spectrum for pixels comprised of increasing numbers of nanorods. The vertical axis on this figure is the normalized scattering cross section (nm²) per nanorod, so that the intensity of different pixels could be appropriately compared. The spectrum of an 85 nm long nanorod (black line, Nx=1 and Ny=1 or 1×1 nanorod) is very broad and symmetric with a peak near 550 nm. As more and more nanorods are added (Nx=3 and Ny=3 or 3×3 nanorod, Nx=5 and Ny=5 or 5×5 nanorods, Nx=10 and Ny=10 or 10×10 nanorods, and Nx=20 and Ny=20 or 20×20 nanorods . with Dₓ and D_{y}=320 nm), the peak scattering intensity per nanorod increases, the D_{y}-based threshold sharpens, and the Dₓ-based dip in the blue portion of the spectrum becomes stronger. The largest pixel in this series, at these Dₓ and D_{y} values, has a footprint of about 6 microns×6 microns. It is anticipated that an “infinite pixel” may look similar to the 20×20 nanorod pixel, but with even more well defined features.

Importantly, this demonstrates that some features of the spectrum that derive from diffractive coupling can be achieved even with pixels that are smaller than discussed above. A plasmonic pixel designed to rely on diffractive coupling for color control can be so small as to contain only 10 to 20 nanorods, making a footprint of approximately 1 micron×1 micron.

The fact that such small-area pixels can have well-defined spectra means that these pixels can also be applied to security applications, including nano-barcodes and anti-counterfeiting. FIG. 13 shows a macroscopic demonstration of an edge-lit pixel with and without a diffuser. The images were taken using a digital camera approximately 10 inches away from a glass slide containing a macroscopic plasmonic pixel, where the nanorods in the pixel were oriented parallel to the direction of incoming light. The camera was placed at varying angles relative to the orientation of the pixel, from directly facing the pixel (0°), to a glancing wide-angle view of the pixel)(˜75°). The pixel had a footprint of 1.5×1.5 mm², and was made of a tiling of 5 micron pixels with nanorod length=75 nm, Dₓ=275 nm, and D_{y}=275 nm. For a pixel viewed with no diffuser, the observed color depends significantly on the viewing angle and the perceived colors are sharp and vivid with violet at the 0° viewing angle and red at the 75° viewing angle.. When a diffuser is placed between the pixels and the viewer, the colors are mixed and depend far less on the position of the observer. The diffuser works to mix wavelengths that are scattered +15° and −15° on either side of the observer's position. If a diffuser with a larger mixing angle were used, 80° for instance, then the observed color would be negligibly affected by the observation angle. The pixel was illuminated from a white light lamp coupled via a fiber into the edge of the slide. In the images with the diffuser, some of the light was also coupled into the diffuser because the fiber end was larger than the glass slide.

This shows the versatility of these pixels. If a diffuser is used, then the pixels can be used exactly as described previously. If no diffuser is used, then the pixel color can be controlled via a mechanism-controlled tilting of the pixel. The rays will scatter from the pixel as discussed further below.

FIG. 14 shows a schematic diagram of observable light rays from the pixel (e.g. FIG. 13). In this diagram, a single pixel is on the top face of the glass slide, and the light is coupled in (e.g. FIG. 13), with the nanorods long axis pointing left to right in this drawing. The color of the pixel can be observed from either the front or back side of the glass slide, but only the first-order back- and forward-refracted rays will be observed, with the first order back-refracted rays brightest. As long as the white light is coupled into the slide in a consistent manner, then the tilt of the sample relative to the observer's eye can control which color is seen. All other rays will be reflected inside the glass slide because of total internal reflection. Even if a diffuser is included on the viewed surface, only the previously described refracted light will be observed. The light will be mixed as shown and described relative to FIG. 13. For a pixel excited as shown, the light will be viewed from the front and right of the display only. However, if a full display comparable to an LCD or other device were created, the pixels can be excited from both the right and left (at the same time, in alternating rows, or some other pattern) to create a more uniform viewing experience. In this way, a sample without a diffuser could be used to control color via tilt angle, where red, green, or blue could be scattered toward the viewer's eye based on the relative tilt angle of the pixel. This would be especially useful in single-user glasses or goggle-like applications, and could be adaptable for multi-viewer large screens as well.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A plasmonic pixel for a display, the plasmonic pixel comprising:
a substrate;
an array of nanoparticles of a plasmonic material deposited on the substrate, wherein a color of the plasmonic material is controlled by a plasmon response of the nanoparticles, a distance between nanoparticles along two or three axial directions, and/or a method of excitation.

2. The plasmonic pixel of claim 1, wherein the color of the plasmonic material is controlled by an aspect ratio of the nanoparticles, and the aspect ratio is equal to or between 1 and 5.

3. The plasmonic pixel of claim 1, wherein the method of excitation is selected from standard reflected and transmitted light, reflected light in a dark-field geometry or high incidence angle excitation, or excitation via an evanescent field through total internal reflection where the substrate acts as an optical waveguide.

4. The plasmonic pixel of claim 1, wherein a plasmon response of the array of nanoparticles is diffractively coupled.

5. The plasmonic pixel of claim 1, further comprising a top layer overcoating the array of nanoparticles.

6. The plasmonic pixel of claim 5, wherein the top layer has a refractive index of approximately 1.5 to 1.7.

7. The plasmonic pixel of claim 5, wherein the top layer is polyimide, or silica, glass, or other transparent material.

8. The plasmonic pixel of claim 1, wherein the array of nanoparticles comprise nanorods, nanoshells, nanoparticles, spiky shells, cubes, triangles, prisms, disks, nanowires, gratings, or Fano structures.

9. The plasmonic pixel of claim 1, wherein the array of nanoparticles are formed from Al, Au, Ag, Si, Cu, Pt, plasmonic metal alloys, or plasmonic semiconductors.

10. The plasmonic pixel of claim 8, wherein the array of nanoparticles comprises nanorods.

11. The plasmonic pixels of claim 8, wherein each of the nanoparticles has approximately equal physical dimensions.

12. The plasmonic pixel of claim 1, wherein a period between nanoparticles of the array of nanoparticles in a specified direction is 2-3 times a dimension of an average nanoparticle in the specified direction.

13. The plasmonic pixel of claim 9, wherein the period is a horizontal period between the nanoparticles in a horizontal direction and the horizontal period is 2-3 times an average width of the nanoparticles; or
the period is a vertical period between the nanoparticles in a vertical direction and the vertical period is 2-3 times an average length of the nanoparticles; or
the period is a layer period between the nanoparticles in different layers and the layer period is 2-3 times an average height of the nanoparticles.

14. The plasmonic pixel of claim 1, wherein the array of nanoparticles is arranged in a square or hexagonal array.

15. The plasmonic pixel of claim 1, wherein a ratio of D_{y}/Dₓ is equal to or between 1-2, where D_{y} is a period along a y direction and Dₓ is a period along an x direction.

16. The plasmonic pixel of claim 1, wherein each nanoparticle of the array of nanoparticles has an approximately identical aspect ratio to provide a pixel of a single color or has different aspect ratios to provide a pixel of a color that is not achievable by a single aspect ratio alone.

17. The plasmonic pixel of claim 1, wherein each nanoparticle of the array of nanoparticles have dimensions equal to or between 10-300 nm or thicknesses equal to or less than 50 nm.

18. A method for controlling a plasmonic pixel for a display, the method comprising:
controlling a color of a plasmonic pixel by controlling a plasmon response of the nanoparticles, a distance between nanoparticles along two or three axial directions, and/or a method of excitation, wherein the plasmonic pixel comprises
a substrate, and
an array of nanoparticles of a plasmonic material deposited on the substrate.

19. The method of claim 18, wherein the color of the plasmonic material is controlled by an aspect ratio of the nanoparticles, and the aspect ratio is equal to or between 1 and 5.

20. The method of claim 18, wherein the method of excitation is selected from standard reflected and transmitted light, reflected light in a dark-field geometry or high incidence angle excitation, or excitation via an evanescent field through total internal reflection where the substrate acts as an optical waveguide.

21. The method of claim 18, wherein a plasmon response of the array of nanoparticles is diffractively coupled.

22. The method of claim 18, wherein the array of nanoparticles comprise nanorods, nanoshells, nanoparticles, spiky shells, cubes, triangles, prisms, disks, nanowires, gratings, or Fano structures.

23. The method of claim 18, wherein the array of nanoparticles are formed from Al, Au, or Ag, Si, Cu, Pt, plasmonic metal alloys, or plasmonic semiconductors.

24. The method of claim 18, wherein each of the nanoparticles has approximately equal physical dimensions.

25. The method of claim 18, wherein a period between nanoparticles of the array of nanoparticles in a specified direction is 2-3 times a dimension of an average nanoparticle in the specified direction.

26. The method of claim 18, wherein a ratio of D_{y}/Dₓ is equal to or between 1-2, where D_{y} is a period between each nanoparticle in the array of nanoparticles along a y direction and Dₓ is a period between each nanoparticle in the array of nanoparticles along an x direction.

27. The method of claim 18, wherein each of the nanoparticles of the array of nanoparticles has an approximately identical aspect ratio to provide a pixel of a single color.

28. The method of claim 18, wherein the array of nanoparticles have different aspect ratios to provide a pixel of a color that is not achievable by a single aspect ratio alone or different aspect ratios to provide a pixel of a color that is not achievable by a single aspect ratio alone.
